(19) United States
(12) Patent Application Publication
(10) Pub. No.: US 2026/0353066 A1
(43) Pub. Date: Nov. 5, 2026

(54) METHOD AND APPARATUS FOR DEVICE FEATURE SUPPORT AND DEVICE CAPABILITY INDICATION FOR ENHANCED REDUCED CAPABILITY USER EQUIPMENT

(71) Applicant: MEDIATEK INC., Hsinchu City (TW)

(72) Inventors: Chiou-Wei TSAI, Hsinchu City (TW); Timothy James FROST, Oulu (FI); Pei-Kai LIAO, Hsinchu City (TW); Wei-De WU, Hsinchu City (TW); Guillaume SEBIRE, Oulu (FI)

(21) Appl. No.: 19/121,241

(22) PCT Filed: Mar. 1, 2024
(86) PCT No.: PCT/CN2024/079523

§ 371 Date: Apr. 15, 2025

Related U.S. Application Data
(60) Provisional application No. 63/487,897, filed on Mar. 2, 2023.
(60) Provisional application No. 63/466,360, filed on May 15, 2023.

(51) Int. Cl. H04W 8/22; H04L 27/26; H04W 74/0836

(52) U.S. Cl. CPC H04W 8/22; H04L 27/26025; H04W 74/0836

(57) ABSTRACT

Various solutions for capability reporting to device feature support and device capability indication for an enhanced reduced capability (eRedCap) user equipment (UE) are described. An apparatus may transmit first UE capability information to a wireless node of a wireless network. The first UE capability information may indicate that the apparatus is an eRedCap UE supporting a reduced peak data rate. The apparatus may also receive a first configuration configuring one or more transmissions or receptions from the network node. The first configuration is based on the reduced peak data rate. The apparatus may further perform the one or more transmissions or receptions according to the first configuration.

### CROSS REFERENCE TO RELATED PATENT APPLICATION(S)

The present disclosure is part of a non-provisional application claiming the priority benefit of U.S. Patent Application No. 63/487,897, filed on 2 Mar. 2023, and U.S. Patent Application No. 63/466,360, filed 15 May 2023. The contents of aforementioned applications are herein incorporated by reference in their entirety.

### TECHNICAL FIELD

The present disclosure is generally related to mobile communications and, more particularly, to device feature support and device capability indication for an enhanced reduced capability (eRedCap) user equipment (UE).

### BACKGROUND

Unless otherwise indicated herein, approaches described in this section are not prior art to the claims listed below and are not admitted as prior art by inclusion in this section.

A new type of UEs called RedCap UEs (also known as NR-Light UEs) with reduced capability is introduced. Generally, the RedCap UEs are associated with lower communicative capabilities when compared to typical UEs (or called non-RedCap UEs), such as high-end UEs supporting enhanced mobile broadband (eMBB) and/or ultra-reliable low latency communications (URLLC) services. For example, the RedCap UEs may be limited in terms of maximum bandwidth (e.g., 20 mega-hertz (MHz) in Frequency Range 1 (FR1), 100 MHz in FR2, etc.). The reduced complexity contributes to more cost-efficient NR-Light devices, longer battery life due to lower power consumption, and a smaller device footprint, which enables newer designs for a broad range of use cases, such as industrial sensors, video surveillance, and wearables.

A further device type (or called eRedCap UEs) with further reduced capability than the legacy RedCap UEs is under study, aiming to further reduce device complexity/cost and power consumption. However, the details of eRedCap UEs have not been fully discussed yet and some issues need to be solved. One of the issues relates to device feature support. Another issue relates to device capability indication. Therefore, there is a need to provide proper schemes to solve these issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to device feature support and device capability indication for an eRedCap UE.

In one aspect, a method may involve an apparatus transmitting first UE capability information to a wireless node of a wireless network, wherein the first UE capability information indicates that the apparatus is an eRedCap UE supporting a reduced peak data rate. The method may also involve the apparatus receiving a first configuration configuring one or more transmissions or receptions from the network node, wherein the first configuration is based on the reduced peak data rate. The method may further involve the apparatus performing the one or more transmissions or receptions according to the first configuration.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising transmitting, via the transceiver, first UE capability information to the wireless node, wherein the first UE capability information indicates that the apparatus is an eRedCap UE supporting a reduced peak data rate. The processor may also perform operations comprising receiving, via the transceiver, a first configuration configuring one or more transmissions or receptions from the network node, wherein the first configuration is based on the reduced peak data rate. The processor may further perform operations comprising performing, via the transceiver, the one or more transmissions or receptions according to the first configuration.

In one aspect, a method may involve a network node receiving first UE capability information from an apparatus, wherein the first UE capability information indicates that the apparatus is an eRedCap UE supporting a reduced peak data rate. The method may also involve the network node transmitting a first configuration configuring one or more transmissions or receptions to the apparatus, wherein the first configuration is based on the reduced peak data rate. The method may further involve the network node performing the one or more transmissions or receptions according to the first configuration.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B 5 G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication system supporting eRedCap UEs and non-RedCap UEs in accordance with an implementation of the present disclosure.

FIG. 2 is a diagram depicting an example scenario of bandwidth configurations of different feature supports for eRedCap UEs in accordance with an implementation of the present disclosure.

FIG. 3 is a diagram depicting an example scenario of a 2-step random access channel (RACH) procedure with UE capability indication for an eRedCap UE in accordance with an implementation of the present disclosure.

FIG. 4 is a diagram depicting an example scenario of a 4-step RACH procedure with UE capability indication for an eRedCap UE in accordance with an implementation of the present disclosure.

FIG. 5 is a diagram depicting an example scenario of a UE capability transfer procedure for an eRedCap UE in accordance with an implementation of the present disclosure.

FIG. 6 is a block diagram of an example communication system in accordance with an implementation of the present disclosure.

FIG. 7 is a flowchart of an example process in accordance with an implementation of the present disclosure.

FIG. 8 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to device feature support and device capability indication for an eRedCap UE. According to the present disclosure, a number of possible solutions may be implemented separately or jointly. That is, although these possible solutions may be described below separately, two or more of these possible solutions may be implemented in one combination or another.

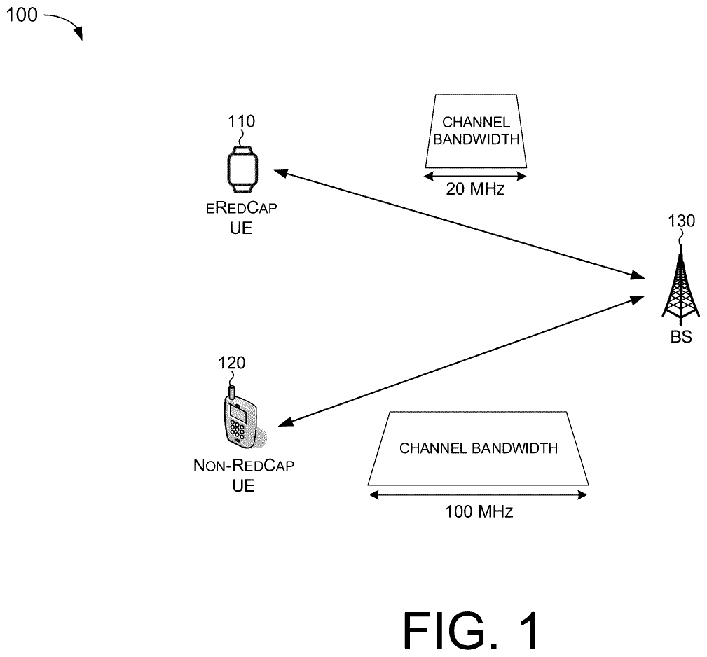

FIG. 1 illustrates an example scenario 100 of a communication system supporting eRedCap UEs and non-RedCap UEs in accordance with an implementation of the present disclosure. Scenario 100 involves a communication system including an eRedCap UE 110, a non-RedCap UE 120 and a base station (BS) 130 (e.g., an evolved Node-B (eNB), a Next Generation Node-B (gNB), or a transmission/reception point (TRP) and so on). The eRedCap UE 110 may refer to a wireless communication apparatus associated with lower communicative capabilities (e.g., operated in a 20 MHz channel bandwidth). For example, the eRedCap UE 110 may be a portable or mobile apparatus, such as an industrial sensor, a video surveillance, or a wearable apparatus (e.g., smartwatch), or may be an immobile/stationary apparatus, such as an IoT, NB-IoT, or IIoT apparatus (e.g., a smart thermostat, a smart fridge, a smart door lock, a wireless speaker or a home control center). The non-RedCap UE 120 may refer to a wireless communication apparatus associated with higher communicative capabilities (e.g., operated in a 100 MHz channel bandwidth). For example, the non-RedCap UE 120 may be a high-end apparatus (e.g., a smartphone, a personal digital assistant, or a computing equipment such as a tablet computer, a laptop computer or a notebook computer) supporting mobile services, such as eMBB, and URLLC services. The BS 130 may belong to part of a radio access network (RAN) of a wireless network (e.g., a 4G/5G/6G system).

Under a proposed scheme in accordance with the present disclosure, different device features corresponding to different peak-rate reduction type are introduced to indicate the UE capability information for eRedCap UEs (e.g., the eRedCap UE 110). The first peak-rate reduction type (also referred to as PR1) indicates that the UE operates in a 20 MHz channel bandwidth with an additional peak rate reduction by reducing the value V_{LAYERS}×Qₘ×f, to limit to a peak data rate of approximately 10 megabits per second (Mbps), where the parameter V_{LAYERS} denotes the maximum supported multiple-input multiple-output (MIMO) layers operated by the UE, the parameter Qₘ denotes the maximum supported modulation order (e.g., 2=QPSK, 4=16 QAM, 6=64 QAM), and the parameter f denotes the scaling factor with values of 1, 0.8, 0.75, and 0.4. Specifically, for PR1, the value V_{LAYERS}×Qₘ×f is 0.75 when V_{LAYERS}=1, or is 0.8 when V_{LAYERS}=2. The second peak-rate reduction type (also referred to as PR3bis) indicates that the UE is limited to operate in a reduced number of physical resource blocks (PRBs) (e.g. 5 MHz of PRBs, i.e., the maximum number of (physical downlink/uplink shared channel (PDSCH/PUSCH) PRBs that can be scheduled/configured for unicast and/or broadcast is 25 PRBs in 15 kilo-hertz (kHz) subcarrier spacing (SCS) or 12 PRBs in 30 kHz SCS) within its operated 20 MHz channel bandwidth, plus additional peak rate reduction to limit to a peak data rate of 10 Mbps. Specifically, for PR 3bis, the additional peak rate reduction is performed by reducing the value V_{LAYERS}×Qₘ×f to 3.2, to limit to 10 Mbps peak data rate. Accordingly, an eRedCap UE (e.g., the eRedCap UE 110) may provide its UE capability information to the network (e.g., the BS 130) to indicate that it is an eRedCap UE. In an example, an eRedCap UE (PR1 and/or PR3bis) supports additional separate early indication for eRedCap UE in Msg3 for 4-step RACH and/or supports additional separate early indication for eRedCap UE in MsgA PUSCH for 2-step RACH if supported. Additionally, the UE capability information may also indicate that it supports either PR1 (i.e., reduced peak data rate without reduced baseband bandwidth) or PR3bits (i.e., reduced peak data rate with reduced baseband bandwidth).

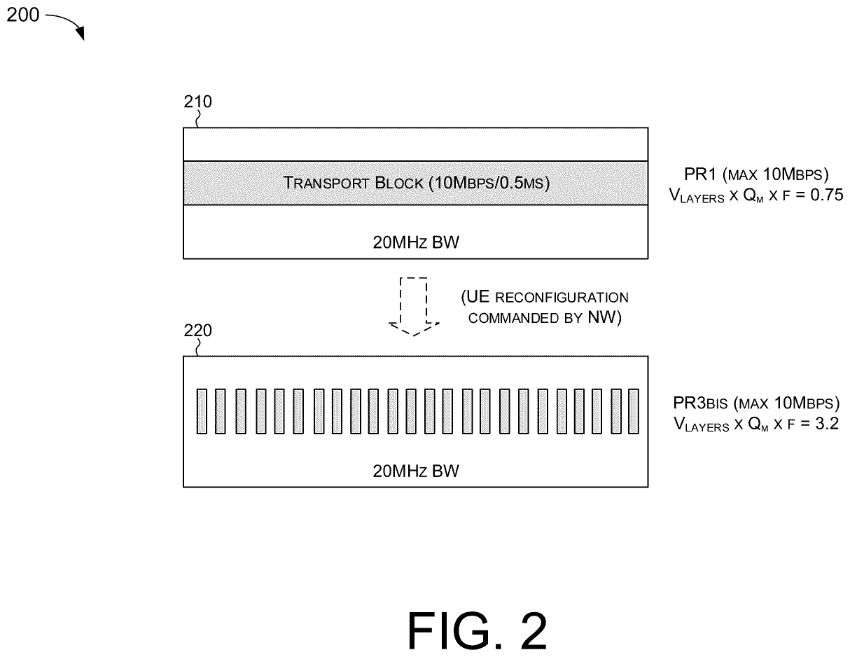

FIG. 2 illustrates an example scenario 200 of bandwidth configurations of different feature supports for eRedCap UEs in accordance with an implementation of the present disclosure. As depicted by the example scenario 200, the bandwidth configuration 210 includes a transport block size scheduled for (PUSCH) transmission(s) and/or (PDSCH) reception(s) based on the feature support for PR1 (e.g., 10 Mbps peak data rate without limitation on the number of PRBs), while the bandwidth configuration 220 includes a reduced/limited PRBs and transport block size scheduled for (PUSCH) transmission(s) and/or (PDSCH) reception(s) based on the feature support for PR3bis (e.g., 10 Mbps peak data rate with reduced number of PRBs). Additionally, or optionally, an eRedCap UE (e.g., the eRedCap UE 110) may be able to signal that it can be (re-)configured to operate as either PR1 or PR3bis by a command from the network. For example, the eRedCap UE may operate as PRI in a network (node) where the network functionality provides radio access configuration limitations according to PR1, and operate as PR3bis in another network(node) that provides radio access configuration limitations according to PR3bis. That is, the eRedCap UE may support different operation modes (i.e., PR1 or PR3bis) based on the network configurations. In addition, eRedCap UE may support both PR1 and PR3bis modes based on the network configurations.

In some implementations, the eRedCap UE may provide an indication to the network of its preference to operate in either PR1 or PR3bis operation mode, or to indicate that it would benefit from the opportunity to conserve its battery. The indication may trigger either a reconfiguration or further reconfiguration. Possible reasons for the eRedCap UE indicating its preference for a certain operation mode may include: (1) the type of deployment scenario, such as a terrestrial network or a non-terrestrial/satellite network (e.g. triggering PR3bis operation mode for non-terrestrial/satellite deployment scenario); (2) the user commands the UE to operate in a power save mode (e.g. triggering PR3bis operation mode); and (3) the type of power supply to the UE changes. Alternatively, the network may initiate the UE reconfiguration to operate in either PR1 or PR3bis operation mode. Possible reasons for selecting either PR1 or PR3bis configuration from the network side may include: (1) the network only supports eRedCap UEs according to one of PR1 or PR3bis and relies on the eRedCap UE using the supported operation mode to ensure interoperability (this may include the scenario where handover is performed between a network supporting only PR1 to a network supporting only PR3bis, or vice versa); and (2) in the case of UE reconfiguration to operate in PR3bis operation mode, the network may determine to allow the UE to support power saving, optionally based on the information provided by the UE about its preferred operation mode or desire to conserve its battery.

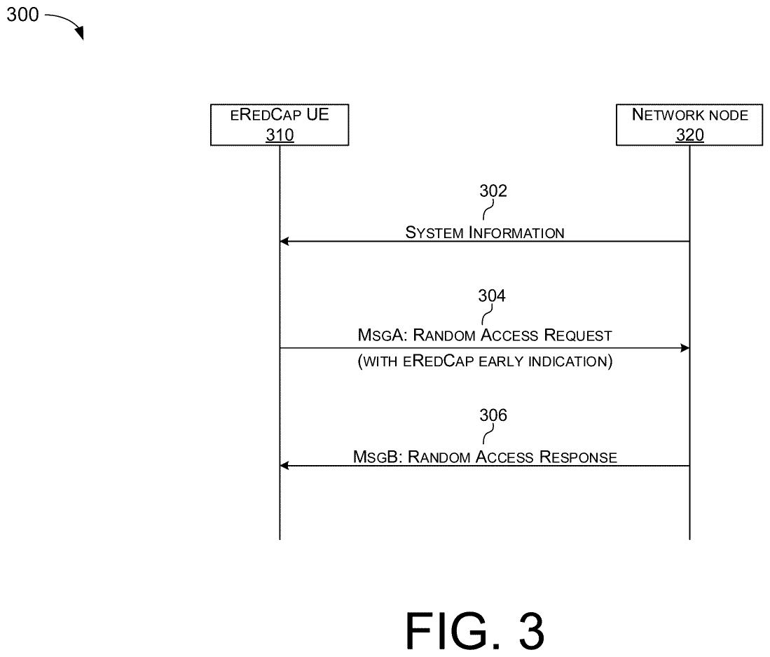

Under a proposed scheme in accordance with the present disclosure, an eRedCap UE may provide its UE capability information to the network during and/or after initial access. FIG. 3 illustrates an example scenario 300 of a 2-step RACH procedure with UE capability indication for an eRedCap UE in accordance with an implementation of the present disclosure. Scenario 300 involves an eRedCap UE 310 and a network node 320 (e.g., a BS) which may be part of a wireless network (e.g., an LTE network, a 5G NR network, an IoT network, or a 6G network). As shown in FIG. 3, at step 302, the eRedCap UE 310 receives system information from the network node 320. The system information may include configurations of radio resources for initial access. More specifically, the configurations for initial access may include configurations of dedicated RACH resource(s) for eRedCap UE. At step 304, the eRedCap UE 310 transmits a random access request (i.e., message-A (MsgA)) to the network node 320 by using the dedicated RACH resource(s) for eRedCap UEs. The MsgA in a 2-step RACH may comprise a PRACH and a PUSCH. At step 306, the network node 320 replies to the eRedCap UE 310 with a random access response (i.e., message-B (MsgB)). As such, use of the dedicated RACH resource(s) for eRedCap UE in MsgA gives an early indication that the initiating UE is an eRedCap UE. An eRedCap early indication based on MsgA (PRACH and/or a PUSCH) for random access can be supported.

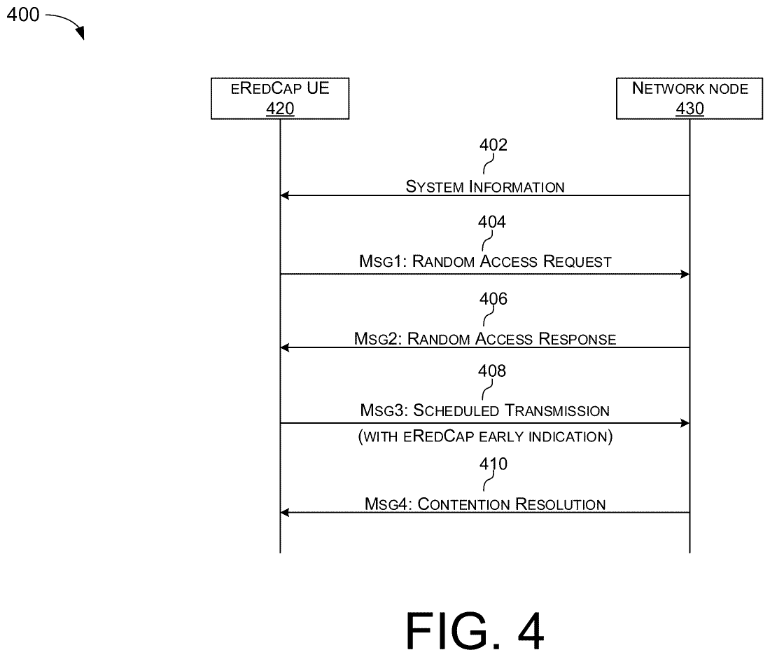

FIG. 4 illustrates an example scenario 400 of a 4-step RACH procedure with UE capability indication for an eRedCap UE in accordance with an implementation of the present disclosure. Scenario 400 involves an eRedCap UE 420 and a network node 430 (e.g., a BS) which may be part of a wireless network (e.g., an LTE network, a 5G NR network, an IoT network, or a 6G network). As shown in FIG. 4, at step 402, the eRedCap UE 420 receives system information from the network node 430. The system information may include configurations of radio resources for initial access and Logical Channel Identifiers (LCID(s)) dedicated for eRedCap UE. At step 404, the eRedCap UE 420 transmits a random access request (i.e., message-1 (Msg1)) to the network node 430 by using the configurations of radio resources for initial access. An early indication for eRedCap UE may be transmitted via Msg1. When Msg1 indication for eRedCap UEs is configured, it is used by eRedCap UEs with or without bandwidth reduction (for PR1 or PR3bis). In other words, a network-configurable RedCap early indication in Msg1 for eRedCap UE can be supported. At step 406, the network node 430 replies to the eRedCap UE 420 with a random access response (i.e., message-2 (Msg2)). Next, at step 408, the eRedCap UE 420 transmits a message of scheduled transmission (i.e., message-3 (Msg3)) to the network node 430 by using a LCID for eRedCap UE. Msg3 PUSCH based early indication for eRedCap UE may be introduced. LCID can be used for eRedCap early indication in Msg3 PUSCH. At step 410, the network node 430 replies to the eRedCap UE 420 with a message of contention resolution (i.e., message-4 (Msg4)). As such, use of the LCID for eRedCap UE in Msg3 gives an early indication that the initiating UE is an eRedCap UE. An eRedCap early indication based on Msg3 (PUSCH) for random access can be supported.

It is noteworthy that, the initial access procedure (i.e., 2-step RACH or 4-step RACH) for eRedCap UE supporting PR1 is the same as that for eRedCap UE supporting PR3bis. That is, the early indication in MsgA PRACH/MsgA PUSCH/Msg3 PUSCH can only indicate that the initiating UE is an eRedCap UE, but it can not be used to identify whether the UE supports PR1 or PR3bis.

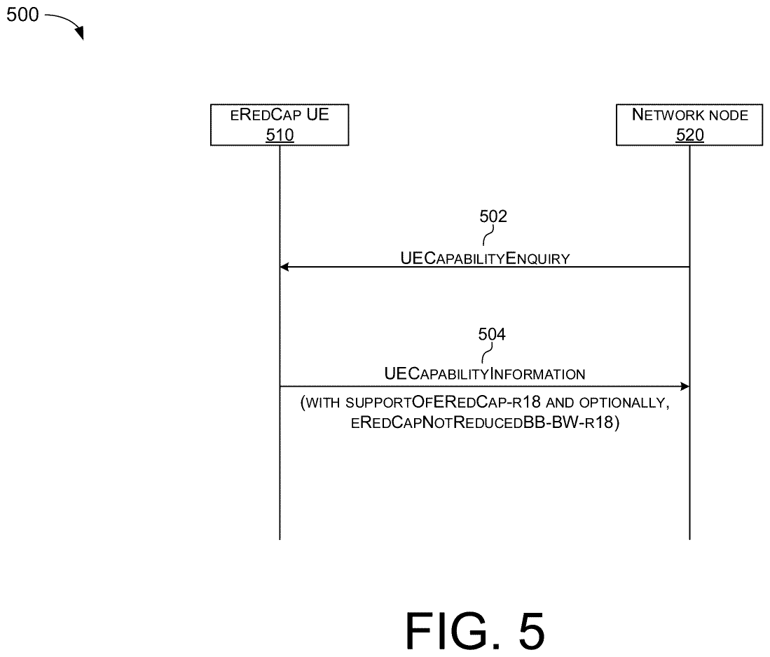

FIG. 5 illustrates an example scenario 500 of a UE capability transfer procedure for an eRedCap UE in accordance with an implementation of the present disclosure. Scenario 500 involves an eRedCap UE 510 and a network node 520 which may be part of a wireless network (e.g., an LTE network, a 5G NR network, an IoT network, or a 6G network). As shown in FIG. 5, at step 502, the network node 520 may initiate the UE capability transfer procedure by transmitting a UECapabilityEnquiry message to the eRedCap UE 510. Specifically, the UE capability transfer procedure may be initiated when the eRedCap UE 510 is in the RRC_CONNECTED state and when the network node 520 needs (additional) UE radio access capability information. At step 504, the eRedCap UE 510 may transmit a UECapability Information message to the network node 520. Specifically, the UECapabilityInformation message may contain UE capability information indicating that the eRedCap UE 510 supports reduced peak data rate with or without reduced baseband bandwidth (i.e., the UE capability information indicates whether the eRedCap UE 510 supports PR1 or PR3bis). For example, the UE capability information may be signaled in one or more information elements (IEs), including supportOfERedCap-r18 and eRedCapNotReducedBB-BW-r18. The IE supportOfERedCap-r18 indicates that the UE is an eRedCap UE with reduced peak data rate and reduced baseband bandwidth in FR1, while the IE eRedCapNotReducedBB-BW-r18 indicates that the UE is an eRedCap UE without reduced baseband bandwidth in FR1. Particularly, a UE supporting eRedCapNotReducedBB-BW-r18 should also indicate the support of supportOfERedCap-r18. In other words, the features of PR1 are indicated by both the IEs supportOfERedCap-r18 and eRedCapNotReducedBB-BW-r18, while the features of PR3bis are indicated by only the IE supportOfERedCap-r18.

### Illustrative Implementations

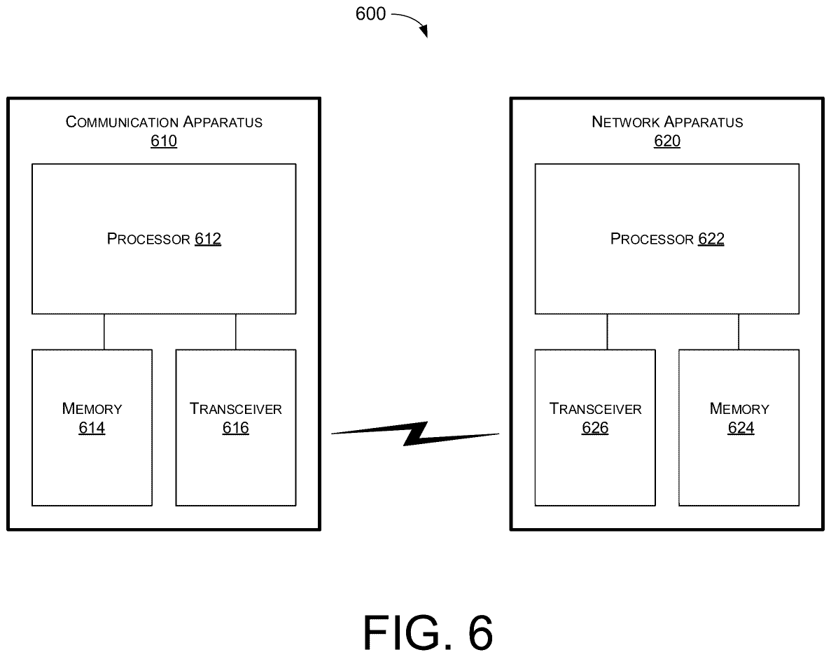

FIG. 6 illustrates an example communication system 600 having an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to device feature support and device capability indication for an eRedCap UE, including scenarios/schemes described above as well as processes 700 and 800 described below.

Communication apparatus 610 may be a part of an electronic apparatus, which may be a UE (e.g., eRedCap UE) such as a portable or mobile apparatus, a wearable apparatus, a wireless communication apparatus or a computing apparatus. For instance, communication apparatus 610 may be implemented in a smartphone, a smartwatch, a personal digital assistant, a digital camera, or a computing equipment such as a tablet computer, a laptop computer or a notebook computer. Communication apparatus 610 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6 such as a processor 612, for example. Communication apparatus 610 may further include one or more other components not pertinent to the proposed scheme of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of an electronic apparatus, which may be a network node such as a BS, a small cell, a router or a gateway. For instance, network apparatus 620 may be implemented in an eNB in an LTE, LTE-Advanced or LTE-Advanced Pro network or in a gNB/TRP in a 5G, NR, IoT, NB-IoT or IIoT network. Alternatively, network apparatus 620 may be implemented in the form of one or more IC chips such as, for example and without limitation, one or more single-core processors, one or more multi-core processors, or one or more RISC or CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks, including device feature support and device capability indication for an eRedCap UE, in a device (e.g., as represented by communication apparatus 610) and a network (e.g., as represented by network apparatus 620) in accordance with various implementations of the present disclosure.

In some implementations, communication apparatus 610 may also include a transceiver 616 coupled to processor 612 and capable of wirelessly transmitting and receiving data. In some implementations, transceiver 616 may be capable of wirelessly communicating with different types of UEs and/or wireless networks of different radio access technologies (RATs). In some implementations, transceiver 616 may be equipped with a plurality of antenna ports (not shown) such as, for example, four antenna ports. That is, transceiver 616 may be equipped with multiple transmit antennas and multiple receive antennas for MIMO wireless communications. In some implementations, network apparatus 620 may also include a transceiver 626 coupled to processor 622. Transceiver 326 may include a transceiver capable of wirelessly transmitting and receiving data. In some implementations, transceiver 626 may be capable of wirelessly communicating with different types of UEs of different RATs. In some implementations, transceiver 626 may be equipped with a plurality of antenna ports (not shown) such as, for example, four antenna ports. That is, transceiver 626 may be equipped with multiple transmit antennas and multiple receive antennas for MIMO wireless communications.

In some implementations, communication apparatus 610 may further include a memory 614 coupled to processor 612 and capable of being accessed by processor 612 and storing data therein. In some implementations, network apparatus 620 may further include a memory 624 coupled to processor 622 and capable of being accessed by processor 622 and storing data therein. Each of memory 614 and memory 624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 624 may include a type of read-only memory (ROM) such as mask ROM, programmable ROM (PROM), erasable programmable ROM (EPROM) and/or electrically erasable programmable ROM (EEPROM). Alternatively, or additionally, each of memory 614 and memory 624 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 610 and network apparatus 620 may be a communication entity capable of communicating with each other using various proposed schemes in accordance with the present disclosure. For illustrative purposes and without limitation, a description of capabilities of communication apparatus 610, as a UE, and network apparatus 620, as a network node (e.g., BS), is provided below.

Under certain proposed schemes in accordance with the present disclosure with respect to device feature support and device capability indication for an eRedCap UE, processor 612 of communication apparatus 610 may transmit, via transceiver 616, first UE capability information to network apparatus 620. Specifically, the first UE capability information (e.g., an early indication in RACH) may indicate that communication apparatus 610 is an eRedCap UE supporting a reduced peak data rate. Then, processor 612 may receive, via transceiver 616, a first configuration configuring one or more transmissions or receptions from network apparatus 620. Specifically, the first configuration may be based on the reduced peak data rate. Also, processor 612 may perform, via transceiver 616, the one or more transmissions or receptions according to the first configuration. Correspondingly, processor 622 of network apparatus 620 may receive, via transceiver 626, the first UE capability information from communication apparatus 610. Then, processor 622 may transmit, via transceiver 626, a first configuration configuring one or more transmissions or receptions to communication apparatus 610. Also, processor 622 may perform, via transceiver 626, the one or more transmissions or receptions according to the first configuration.

In some implementations, processor 612 may also transmit, via transceiver 616, second UE capability information to network apparatus 620, wherein the second UE capability information (e.g., UE capability reporting in connected mode) indicates that communication apparatus 610 is the eRedCap UE supporting the reduced peak data rate with or without a reduced baseband bandwidth.

In some implementations, the one or more transmissions or receptions may be further based on a maximum number of PRBs.

In some implementations, the maximum number of PRBs may include 25 PRBs for 15 kHz SCS or 12 PRBs for 30 kHz SCS.

In some implementations, the reduced peak data rate may be approximately 10 Mbps. For example, depending on the combination of UL/DL and SCSs (15kHz or 30 kHz), the obtained data rate may range from 10.x Mbps to 12.x Mbps.

In some implementations, in a case that communication apparatus 610 is the eRedCap UE supporting the reduced peak data rate without the reduced baseband bandwidth, a product of a maximum number of MIMO layers, a maximum modulation order, and a scaling factor corresponding to the reduced peak data rate may be 0.75 when the maximum number of MIMO layers is 1, or may be 0.8 when the maximum number of MIMO layers is 2.

In some implementations, in a case that communication apparatus 610 is the eRedCap UE supporting the reduced peak data rate with the reduced baseband bandwidth, a product of a maximum number of MIMO layers, a maximum modulation order, and a scaling factor corresponding to the reduced peak data rate may be 3.2.

In some implementations, the first UE capability information may include an early indication for the eRedCap UE in a Msg3 or Msg1 during a 4-step RACH procedure, or an early indication for the eRedCap UE in a MsgA during a 2-step RACH procedure.

### Illustrative Processes

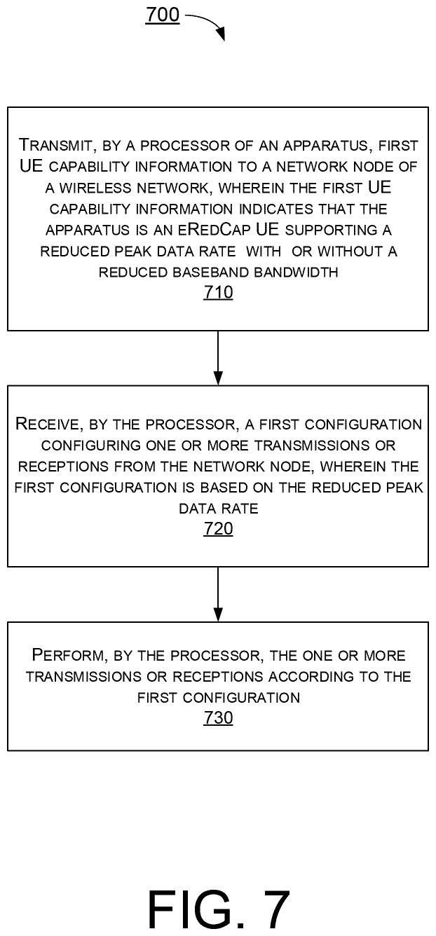

FIG. 7 illustrates an example process 700 in accordance with an implementation of the present disclosure. Process 700 may be an example implementation of above scenarios/schemes, whether partially or completely, with respect to device feature support and device capability indication for an eRedCap UE. Process 700 may represent an aspect of implementation of features of communication apparatus 610. Process 700 may include one or more operations, actions, or functions as illustrated by one or more of blocks 710 to 730. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by or in communication apparatus 610 or any suitable UE or machine type devices. Solely for illustrative purposes and without limitation, process 700 is described below in the context of communication apparatus 610. Process 700 may begin at block 710.

At 710, process 700 may involve processor 612 of communication apparatus 610 transmitting, via transceiver 616, first UE capability information to a network node (e.g., network apparatus 620) of a wireless network. The first UE capability information may indicate that communication apparatus 610 is an eRedCap UE supporting a reduced peak data rate. Process 700 may proceed from 710 to 720.

At 720, process 700 may involve processor 612 receiving, via transceiver 616, a first configuration configuring one or more transmissions or receptions from the network node. The first configuration may be based on the reduced peak data rate. Process 700 may proceed from 720 to 730.

At 730, process 700 may involve processor 612 performing, via transceiver 616, the one or more transmissions or receptions according to the first configuration.

In some implementations, process 700 may further involve processor 612 transmitting, via transceiver 616, second UE capability information to the network node, wherein the second UE capability information indicates that communication apparatus 610 is the eRedCap UE supporting the reduced peak data rate with or without a reduced baseband bandwidth.

In some implementations, the one or more transmissions or receptions may be further based on a maximum number of PRBs.

In some implementations, the maximum number of PRBs may include 25 PRBs for 15 kHz SCS or 12 PRBs for 30 kHz SCS.

In some implementations, the reduced peak data rate may be approximately 10 Mbps.

In some implementations, in a case that communication apparatus 610 is the eRedCap UE supporting the reduced peak data rate without the reduced baseband bandwidth, a product of a maximum number of MIMO layers, a maximum modulation order, and a scaling factor corresponding to the reduced peak data rate may be 0.75 when the maximum number of MIMO layers is 1, or may be 0.8 when the maximum number of MIMO layers is 2.

In some implementations, in a case that communication apparatus 610 is the eRedCap UE supporting the reduced peak data rate with the reduced baseband bandwidth, a product of a maximum number of MIMO layers, a maximum modulation order, and a scaling factor corresponding to the reduced peak data rate may be 3.2.

In some implementations, the first UE capability information may include an early indication for the eRedCap UE in a Msg3 or Msg1 during a 4-step RACH procedure, or an early indication for the eRedCap UE in a MsgA during a 2-step RACH procedure.

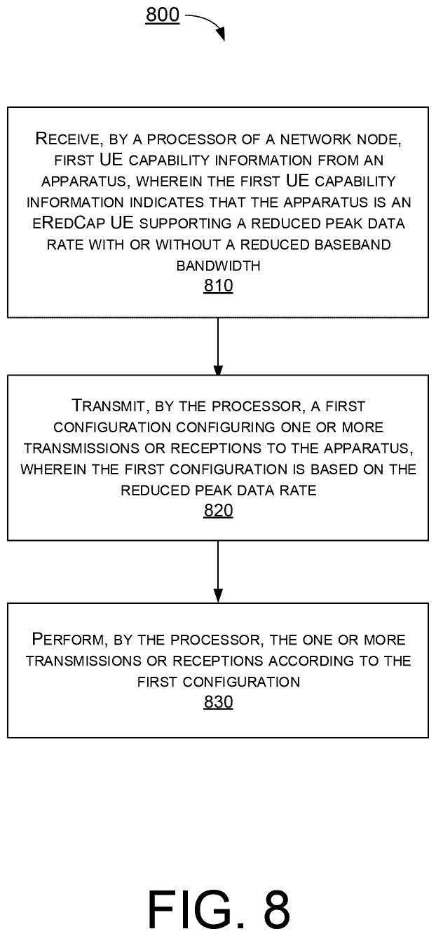

FIG. 8 illustrates an example process 800 in accordance with an implementation of the present disclosure. Process 800 may be an example implementation of above scenarios/schemes, whether partially or completely, with respect to device feature support and device capability indication for an eRedCap UE. Process 800 may represent an aspect of implementation of features of network apparatus 620. Process 800 may include one or more operations, actions, or functions as illustrated by one or more of blocks 810 to 830. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by or in network apparatus 620 as well as any variations thereof. Solely for illustrative purposes and without limitation, process 800 is described below in the context of network apparatus 620. Process 800 may begin at block 810.

At 810, process 800 may involve processor 622 of network apparatus 620 receiving, via transceiver 626, first UE capability information from an apparatus (e.g., communication apparatus 610). The first UE capability information may indicate that communication apparatus 610 is an eRedCap UE supporting a reduced peak data rate. Process 800 may proceed from 810 to 820.

At 820, process 800 may involve processor 622 transmitting, via transceiver 626, a first configuration configuring one or more transmissions or receptions to communication apparatus 610. The first configuration may be based on the reduced peak data rate. Process 800 may proceed from 820 to 830.

At 830, process 800 may involve processor 622 performing, via transceiver 626, the one or more transmissions or receptions according to the first configuration.

In some implementations, process 800 may further involve processor 622 receiving, via transceiver 626, second UE capability information from communication apparatus 610, wherein the second UE capability information indicates that communication apparatus 610 is the eRedCap UE supporting the reduced peak data rate with or without a reduced baseband bandwidth.

In some implementations, the one or more transmissions or receptions may be further based on a maximum number of PRBs.

In some implementations, the maximum number of PRBs may include 25 PRBs for 15 kHz SCS or 12 PRBs for 30 kHz SCS.

In some implementations, the reduced peak data rate may be approximately 10 Mbps.

In some implementations, the first UE capability information may include an early indication for the eRedCap UE in a Msg3 or Msg1 during a 4-step RACH procedure, or an early indication for the eRedCap UE in a MsgA during a 2-step RACH procedure.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus, first user equipment (UE) capability information to a network node of a wireless network, wherein the first UE capability information indicates that the apparatus is an enhanced reduced capability (eRedCap) UE supporting a reduced peak data rate;
receiving, by the processor, a first configuration configuring one or more transmissions or receptions from the network node, wherein the first configuration is based on the reduced peak data rate; and
performing, by the processor, the one or more transmissions or receptions according to the first configuration.

2. The method of claim 1, further comprising:
transmitting, by the processor, second UE capability information to the network node, wherein the second UE capability information indicates that the apparatus is the eRedCap UE supporting the reduced peak data rate with or without a reduced baseband bandwidth.

3. The method of claim 1, wherein the one or more transmissions or receptions are further based on a maximum number of physical resource blocks (PRBs).

4. The method of claim 3, wherein the maximum number of PRBs comprises 25 PRBs for 15 kilo-hertz (kHz) subcarrier spacing (SCS) or 12 PRBs for 30 kHz SCS.

5. The method of claim 1, wherein the reduced peak data rate is approximately 10 megabits per second (Mbps).

6. The method of claim 2, wherein, in a case that the apparatus is the eRedCap UE supporting the reduced peak data rate without the reduced baseband bandwidth, a product of a maximum number of MIMO layers, a maximum modulation order, and a scaling factor corresponding to the reduced peak data rate is 0.75 when the maximum number of MIMO layers is 1, or is 0.8 when the maximum number of MIMO layers is 2.

7. The method of claim 2, wherein, in a case that the apparatus is the eRedCap UE supporting the reduced peak data rate with the reduced baseband bandwidth, a product of a maximum number of MIMO layers, a maximum modulation order, and a scaling factor corresponding to the reduced peak data rate is 3.2.

8. The method of claim 1, wherein the first UE capability information comprises:
an early indication for the eRedCap UE in a Msg3 or Msg1 during a 4-step RACH procedure; or
an early indication for the eRedCap UE in a MsgA during a 2-step RACH procedure.

9. An apparatus, comprising:
a transceiver which, during operation, wirelessly communicates with a network node of a wireless network; and
a processor communicatively coupled to the transceiver such that, during operation, the processor performs operations comprising:
transmitting, via the transceiver, first user equipment (UE) capability information to the network node, wherein the first UE capability information indicates that the apparatus is an enhanced reduced capability (eRedCap) UE supporting a reduced peak data rate;
receiving, via the transceiver, a first configuration configuring one or more transmissions or receptions from the network node, wherein the first configuration is based on the reduced peak data rate; and
performing, via the transceiver, the one or more transmissions or receptions according to the first configuration.

10. The apparatus of claim 9, wherein, during operation, the processor further performs operations comprising:
transmitting, via the transceiver, second UE capability information to the network node, wherein the second UE capability information indicates that the apparatus is the eRedCap UE supporting the reduced peak data rate with or without a reduced baseband bandwidth.

11. The apparatus of claim 9, wherein the one or more transmissions or receptions are further based on a maximum number of physical resource blocks (PRBs).

12. The apparatus of claim 11, wherein the maximum number of PRBs comprises 25 PRBs for 15 kilo-hertz (kHz) subcarrier spacing (SCS) or 12 PRBs for 30 kHz SCS.

13. The apparatus of claim 9, wherein the reduced peak data rate is approximately 10 megabits per second (Mbps).

14. The apparatus of claim 10, wherein:
in a case that the apparatus is the eRedCap UE supporting the reduced peak data rate without the reduced baseband bandwidth, a product of a maximum number of MIMO layers, a maximum modulation order, and a scaling factor corresponding to the reduced peak data rate is 0.75 when the maximum number of MIMO layers is 1, or is 0.8 when the maximum number of MIMO layers is 2; or
in a case that the apparatus is the eRedCap UE supporting the reduced peak data rate with the reduced baseband bandwidth, a product of a maximum number of MIMO layers, a maximum modulation order, and a scaling factor corresponding to the reduced peak data rate is 3.2.

15. The apparatus of claim 9, wherein the first UE capability information comprises:
an early indication for the eRedCap UE in a Msg3 or Msg1 during a 4-step RACH procedure; or
an early indication for the eRedCap UE in a MsgA during a 2-step RACH procedure.

16. A method, comprising:
receiving, by a processor of a network node, first user equipment (UE) capability information from an apparatus, wherein the first UE capability information indicates that the apparatus is an enhanced reduced capability (eRedCap) UE supporting a reduced peak data rate;
transmitting, by the processor, a first configuration configuring one or more transmissions or receptions to the apparatus, wherein the first configuration is based on the reduced peak data rate; and
performing, by the processor, the one or more transmissions or receptions according to the first configuration.

17. The method of claim 16, further comprising:
receiving, by the processor, second UE capability information from the apparatus, wherein the second UE capability information indicates that the apparatus is the eRedCap UE supporting the reduced peak data rate with or without a reduced baseband bandwidth.

18. The method of claim 16, wherein the one or more transmissions or receptions are further based on a maximum number of physical resource blocks (PRBs), and the maximum number of PRBs comprises 25 PRBs for 15 kilo-hertz (kHz) subcarrier spacing (SCS) or 12 PRBs for 30 KHz SCS.

19. The method of claim 16, wherein the reduced peak data rate is approximately 10 megabits per second (Mbps).

20. The method of claim 16, wherein the first UE capability information comprises:
an early indication for the eRedCap UE in a Msg3 or Msg1 during a 4-step RACH procedure; or
an early indication for the eRedCap UE in a MsgA during a 2-step RACH procedure.
